(19) United States
(12) Patent Application Publication
(10) Pub. No.: US 2005/0253866 A1
(43) Pub. Date: Nov. 17, 2005

(54) Method and apparatus for creating profile

(75) Inventors: Kyeong-man Kim, Suwon-si (KR); Hyun-soo Oh, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/130,152

(22) Filed: May 17, 2005

(30) Foreign Application Priority Data
May 17, 2004 (KR) 10-2004-34633

(51) Int. Cl. G09G 5/02

(52) U.S. Cl. 345/594; 345/593

(57) ABSTRACT

A profile creation method and apparatus that allow a user to select a gamut mapping algorithm and create a profile using the selected gamut mapping algorithm. The profile creation apparatus has an interface unit through which a selection command is input, a memory unit storing a plurality of gamut mapping algorithms, and a profile creator creating an output profile of an output unit using the profile data of the output unit and a gamut mapping algorithm selected according to the selection command, from among the plurality of gamut mapping algorithms.

### CROSS-REFERENCE TO RELATED APPLICATIONS

This application claims the priority of Korean Patent Application No. 2004-34633, filed on May 17, 2004, in the Korean Intellectual Property Office, the disclosure of which is incorporated herein by reference.

### BACKGROUND OF THE INVENTION

1. Field of the Invention

The present invention relates to a profile creation method and apparatus, and more particularly, to a profile creation method and apparatus, which allow a user to select a predetermined Gamut Mapping Algorithm (GMA) and create a profile using the selected Gamut Mapping Algorithm.

2. Description of the Related Art

FIG. 1 shows gamuts which can be expressed by a monitor that uses image data of an RGB (Red, Green, Blue) color space and by an image print apparatus that uses image data of a CMYK (Cyan, Magenta, Yellow, Black) color space, respectively. Various digital imaging devices such as digital cameras, scanners, monitors, and printers create and display color images and print these color images. Such digital imaging devices use different color spaces, and each digital imaging device has its own unique gamut. For example, as shown in FIG. 1, a monitor uses image data of an RGB color space, while an image printer uses image data of a CMYK color space. Also, the monitor can express a gamut wider than the image printer. Since a digital imaging device has its own unique color space, a color space of such a digital imaging device is called a Device Dependent Color Space. As such, since each digital imaging device has a unique color space and a unique gamut, a color space and gamut of an input digital imaging device must be matched to those of an output digital imaging device so that a color image input to the input digital imaging device is outputted as a same color image through the output digital imaging device.

FIG. 2 shows a conventional color matching system (CMS). The International Color Consortium (ICC) has proposed an ICC profile for matching color spaces and gamuts between different digital imaging devices. Referring to FIG. 2, a gamut of a digital imaging device is calibrated and the calibrated value is converted to an ICC profile connection space being a standard gamut proposed by the ICC. Accordingly, profile data which includes a color conversion lookup table for converting the color space of the digital imaging device to the profile connection space, is created. As the profile connection space, for example, a color space such as CIELab and CIEXYZ can be used. Also, the different gamuts of different imaging devices are mapped according to a predetermined gamut mapping algorithm. Accordingly, an output profile is created using the profile data of an output unit and the predetermined gamut mapping algorithm.

FIG. 3 shows a conventional profile creation apparatus 300. The conventional profile creation apparatus 300 includes a memory 310 and a profile creator 320. The memory 310 stores a gamut mapping algorithm defined by a manufacturer of the profile creation apparatus. The profile creator 320 receives profile data of an output unit and the gamut mapping algorithm and creates an output profile of the output unit. The output profile of the output unit includes three gamut mapping lookup tables with three different categories, that is, ‘perceptual’, ‘saturated’, and ‘absolute and relative colorimetric’.

The memory 310 of the conventional profile creation apparatus stores only a predetermined gamut mapping algorithm pre-defined by the manufacturer of the profile creation apparatus. Accordingly, regarding mapping algorithms, the profile creator 320 creates the three gamut mapping lookup tables using only the predetermined gamut mapping algorithm, and creates the output profile of the output unit including the three gamut mapping lookup tables. Therefore, the conventional profile creation apparatus cannot reflect a user's preference when creating the output profile of the output unit, and requires a separate edit system capable of additionally editing an output profile created by a user, to reflect the user's preference. Also, the conventional profile creation apparatus does not allow a user to preview a result processed by a predetermined gamut mapping algorithm when a profile is created.

### SUMMARY OF THE INVENTION

The present invention provides a profile creation method and apparatus for creating a profile using a gamut matching algorithm selected by a user.

The present invention also provides a computer-readable medium having embodied thereon a computer program for executing the profile creation method.

According to an aspect of the present invention, there is provided a profile creation apparatus, which creates an output profile of an output unit using profile data of the output unit created on the basis of a color characteristic of the output unit and a gamut mapping algorithm, comprising: an interface unit through which a selection command is input; a memory unit storing a plurality of gamut mapping algorithms; and a profile creator creating the output profile of the output unit, using the profile data of the output unit and a gamut mapping algorithm selected by the selection command from among the plurality of gamut mapping algorithms.

According to another aspect of the present invention, there is provided a profile creation apparatus, which creates an output profile of an output unit, using profile data of the output unit created on the basis of a color characteristic of the output unit and a gamut mapping algorithm, comprising: an interface unit through which a selection command is input; a memory unit storing a plurality of gamut mapping algorithms and a plurality of test color image data; a profile creator creating the output profile of the output unit, using the profile data of the output unit and a gamut mapping algorithm selected by the selection command among the plurality of gamut mapping algorithms; a conversion unit converting test color image data selected by the selection command from among the plurality of test color image data to color image data of the output unit, using the created output profile of the output unit; and a display displaying the converted color image data.

According to another aspect of the present invention, there is provided a profile creation method, which creates an output profile of an output unit using profile data of the output unit created on the basis of a color characteristic of the output unit and a gamut mapping algorithm, the method comprising: (a) receiving the profile data of the output unit; (b) selecting the gamut mapping algorithm; and (c) creating the output profile of the output unit using the profile data of the output unit and the selected gamut mapping algorithm.

According to another aspect of the present invention, there is provided an profile creation method, which creates an output profile of an output unit using profile data of the output unit created on the basis of a color characteristic of the output unit and a gamut mapping algorithm, comprising: (a) receiving the profile data of the output unit; (b) selecting the gamut mapping algorithm; (c) creating a temporary output profile of the output unit using the profile data of the output unit and the selected gamut mapping algorithm; (d) selecting test color image data and converting the selected test color image data to color image data of the output unit on the basis of the temporary output profile; (e) converting the color image data of the output unit to color image data of a display and displaying the color image data of the display on the display; (f) determining, using the color mage data displayed on the display, whether the temporary output profile is correct; and (g) if it is determined that the temporary output profile is correct, selecting the temporary output profile as the output profile of the output unit.

Additional aspects and/or advantages of the invention will be set forth in part in the description which follows, and in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 shows gamuts that can be expressed by a monitor that uses image data of an RGB color space and by an image print apparatus that uses image data of a CMYK color space, respectively;

FIG. 2 shows a conventional color matching system;

FIG. 3 shows a conventional profile creation apparatus;

FIG. 4 is a functional block diagram of a profile creation apparatus according to an embodiment of the present invention;

FIG. 5 is a functional block diagram of a profile creation apparatus according to another embodiment of the present invention;

FIG. 6 illustrates a structure of a profile created by a profile creation apparatus according to an embodiment of the present invention;

FIG. 7 is a flowchart illustrating a profile creation method according to an embodiment of the present invention;

FIG. 8 is a flowchart illustrating a profile creation method according to another embodiment of the present invention; and

FIG. 9 is a flowchart illustrating a detailed process for implementing operation 850 and operation 860 of FIG. 8.

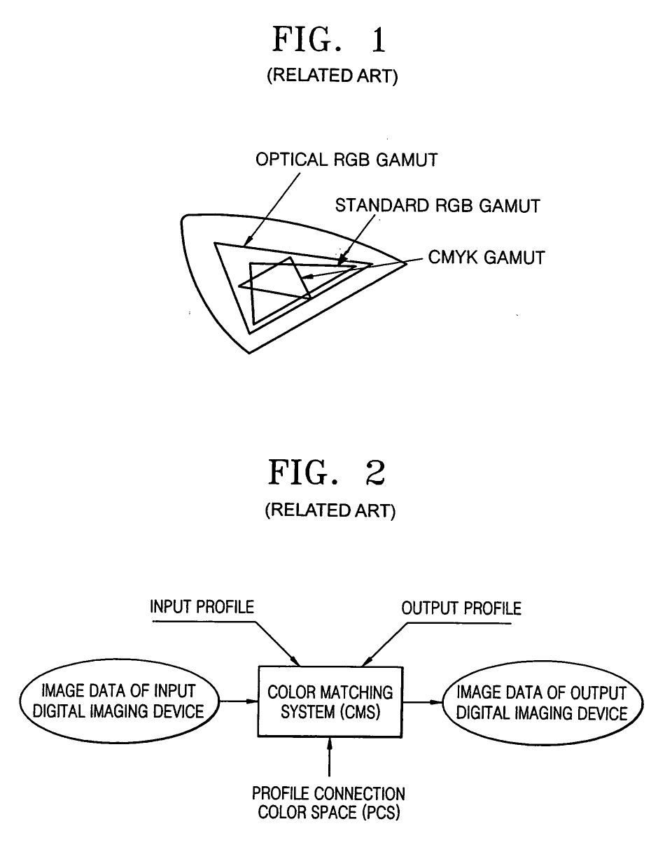

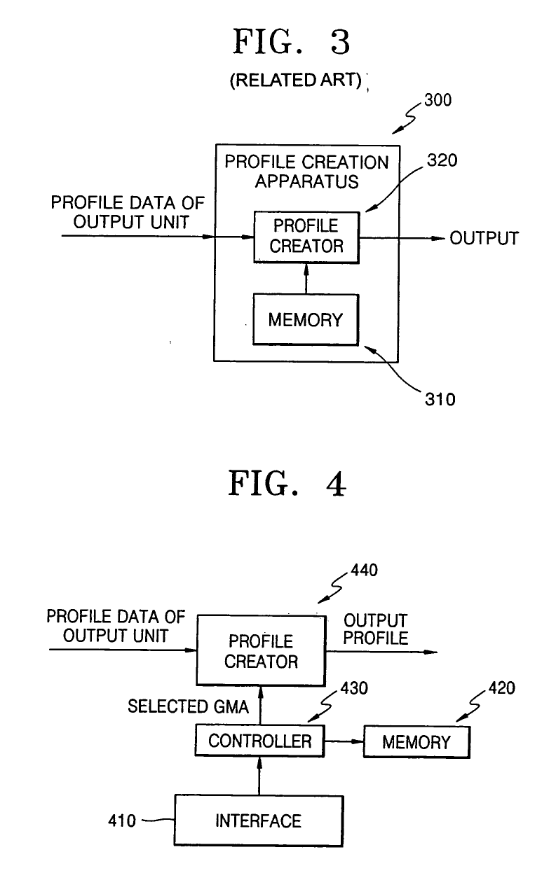

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The described embodiments explain the present invention by referring to the figures.

FIG. 4 is a functional block diagram of a profile creation apparatus according to an embodiment of the present invention. The profile creation apparatus includes an interface 410, a memory 420, a controller 430, and a profile creator 440. The memory 420 stores a plurality of gamut mapping algorithms. The gamut mapping algorithms, for example, include an LCLIP algorithm which first adjusts brightnesses of gamuts of a monitor and an image print apparatus and then clips chroma; an LLIN algorithm which adjusts brightnesses of gamuts of a monitor and an image print apparatus and linearly compresses chroma; an LNLIN algorithm which first adjusts brightnesses of gamuts of a monitor and an image print apparatus and non-linearly compresses chroma; an SLIN algorithm which linearly compresses brightnesses of gamuts of a monitor and an image print apparatus toward an achromatic color point with brightness of 50; an LSLIN algorithm which compresses the brightness while executing the SLIN algorithm; an SLINLAB algorithm which executes the SLIN algorithm in an expanded color space of CIELAB; a CUSP algorithm which performs compression up to the brightness of a point with maximum chroma; and an algorithm which clips chroma to parts with smallest color differences. The gamut mapping algorithm includes various gamut mapping algorithms according to applications of the present invention, and it should be understood that these various gamut mapping algorithms are within the scope of the present invention.

A user inputs a predetermined selection command through the interface 410. The user can select a predetermined gamut mapping algorithm according to his/her preference through the interface 410. The interface 410 may be a graphic user interface. The user can select, through the interface 410, three gamut mapping algorithms used for creating three different gamut mapping lookup tables, that is, ‘perceptual’, ‘saturated’, and ‘absolute and relative colorimetric’. Meanwhile, gamut mapping algorithm combinations each having three gamut mapping algorithms used for creating respective gamut mapping lookup tables, are provided by a manufacturer of the profile creation apparatus. The user can select a gamut mapping algorithm combination among the gamut mapping algorithm combinations through the interface 410. If a selection command for a gamut mapping algorithm is input through the interface 410 by the user, the controller 430 accesses the memory 420, extracts a gamut mapping algorithm corresponding to the selection command, and provides the extracted gamut mapping algorithm to the profile creator 440. The profile creator 440 receives profile data created on the basis of a color characteristic of the output unit and the gamut mapping algorithm provided by the controller 430, and creates an output profile of the output unit.

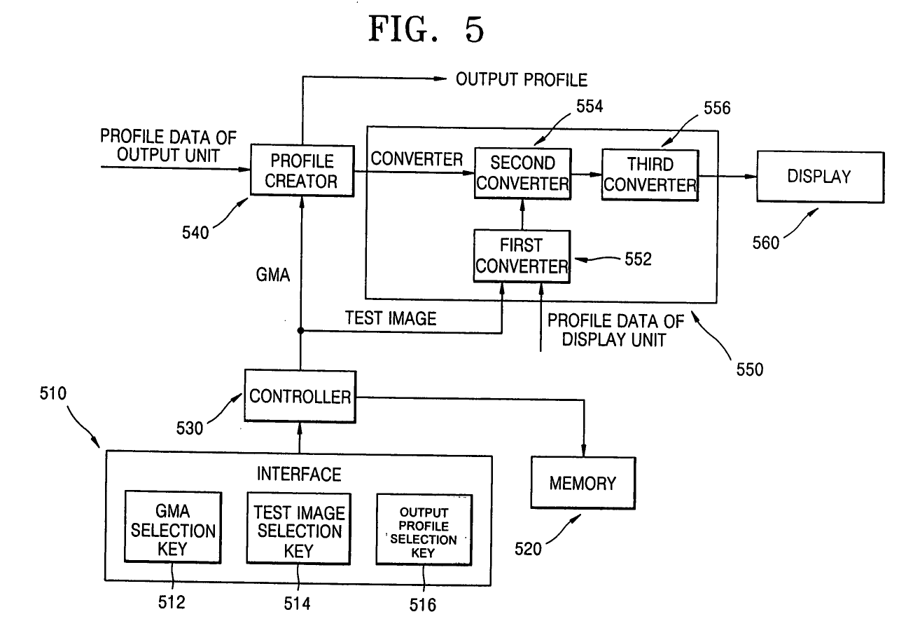

FIG. 5 is a functional block diagram of a profile creation apparatus according to another embodiment of the present invention. The profile creation apparatus includes an interface 510, a memory 520, a controller 530, a profile creator 540, a conversion unit 550, and a display 560.

The memory 520 stores a plurality of gamut mapping algorithms and a plurality of test images. The test image may be a color image including a wide gamut capable of being displayed by a monitor (not shown). The interface 510 includes three selection keys through which a user inputs a selection command. The interface 510 may be a graphic user interface. A gamut mapping algorithm (GMA) selection key 512 is a selection key for selecting a gamut mapping algorithm according to a user's preference, a test image selection key 514 is a selection key for selecting one of the test images, and an output profile selection key 516 is a selection key for selecting the created output profile as an output profile of the output unit when a user's desired output profile is created.

The controller 530 accesses the memory 520 according to a user's profile selection command received through the interface 510 and extracts predetermined data, or selects an output profile created by the profile creator 540 as an output profile of the output unit according to a user's profile selection command.

The profile creator 540 receives profile data of the output unit created on the basis of a color characteristic of the output unit and the gamut mapping algorithm selected by the user through the gamut mapping algorithm selection key 512 of the interface 510, and creates an output profile. The profile creator 540 creates three different gamut mapping lookup table, that is, ‘perceptual’, ‘saturated’, and ‘absolute and relative colorimetric’, using three gamut mapping algorithms selected by the gamut mapping algorithm selection key 512, or a gamut mapping algorithm combination among predetermined gamut mapping algorithm combinations, each including three different gamut mapping algorithms.

The conversion unit 550 receives the output profile of the output unit created by the profile creator 540 and a predetermined test image selected according to a user's test color image selection command received through the test image selection key 514 of the interface 510. The conversion unit 550 includes: a first converter 552, which converts the test color image data to image data of a profile connection space according to display profile data created on the basis of a color characteristic of the display 560; a second converter 554, which converts the color image data of the profile connection space to color image data of the output unit using the created output profile; and a third converter 556, which converts the color image data of the output unit to color image data of the display 560.

If the output unit is an image print apparatus and the profile connection space is a CIELAB color space, the first converter 552 converts test image data of an RGB (Red, Green, Blue) color space to image data of a CIELAB color space on the basis of profile data of the display 560. The second converter 554 converts the image data of the CIELAB color space to image data of a CMYK (Cyan, Magenta, Yellow, Black) color space on the basis of the created output profile. The third converter 556 converts the image data of the CMYK color space to image data of an RGB color space. The third converter 556 can perform soft proofing of testing a color image to be printed using a display, such as a CRT or a PDP monitor, before printing the image data of the CMYK color space through a printer or other image print apparatus.

By displaying the color image data provided by the converter 550 on the display 560, it is possible to preview the color image data to be printed. Accordingly, the user selects a gamut mapping algorithm according to his or her preference, and can preview, through the display 560, a print result of color image data that will be printed according to an output profile created by the selected gamut mapping algorithm, before the color image data is actually printed.

To select an output profile generated on the basis of the selected gamut mapping algorithm as an output profile of the output unit, the user inputs an output profile selection command using the output profile selection key 516 of the interface 510.

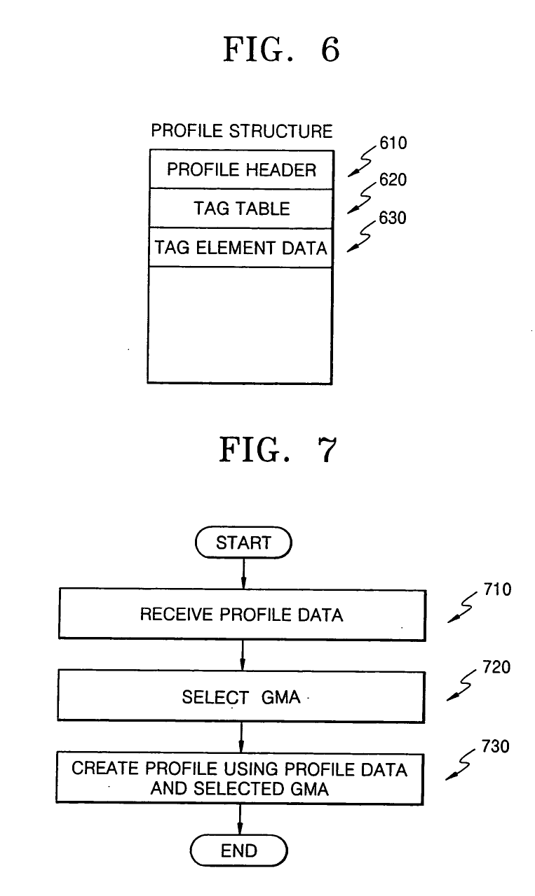

FIG. 6 illustrates a structure of a profile created by a profile creation apparatus according to an embodiment of the present invention. An output profile of the output unit includes a profile header 610, a tag table 620, and tag element data 630. The profile header 610 stores schematic information regarding the output profile, including a total size of the output profile, a type of the output unit, a creation date of the profile, etc. The tag element data 630 includes three gamut mapping lookup tables created by gamut mapping algorithms selected by a user. The tap table 620 includes signatures indicating locations in which the respective gamut mapping lookup tables are stored, and information regarding the sizes of the respective gamut mapping lookup tables.

FIG. 7 is a flowchart illustrating a profile creation method according to an embodiment of the present invention. FIG. 7 shows a profile creation method performed by the profile creator of FIG. 4. Referring to FIG. 7, first, profile data of the output unit created on the basis of a color characteristic of the output unit is received in operation 710. Then, a predetermined gamut mapping algorithm is selected by a user selection command received through the interface 410 in operation 720.

To create three different gamut mapping lookup tables, a user selects three gamut mapping algorithms, or selects a gamut mapping algorithm combination among gamut mapping algorithm combinations with three gamut mapping algorithms, using the interface 410. Successively, an output profile of the output unit is created on the basis of the profile data of the output unit and the selected gamut mapping algorithm in operation 730. The created output profile of the output unit includes three gamut mapping lookup tables, which are created by the three gamut mapping algorithms selected by the user through the interface 410 or by the gamut mapping algorithm combination including three gamut mapping algorithms.

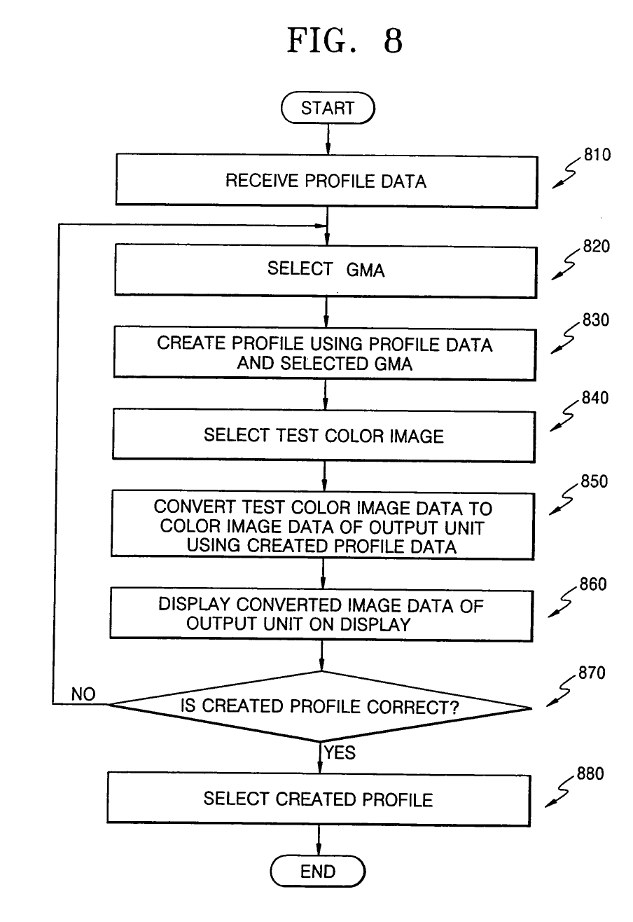

FIG. 8 is a flowchart illustrating a profile creation method according to another embodiment of the present invention. FIG. 8 shows a profile creation method performed by the profile creator of FIG. 5. First, profile data of the output unit created on the basis of a color characteristic of the output unit is received in operation 810. Then, a predetermined gamut mapping algorithm is selected by a user's selection command received through the gamut mapping algorithm selection key 512 in operation 820. Successively, an output profile of the output unit is created on the basis of the profile data of the output unit and the gamut mapping algorithms in operation 830. Operations 810 through 830 of FIG. 8 correspond to operations 710 through 730 of FIG. 7, respectively.

Next, the user selects a predetermined test color image through the test image selection key 514 in operation 840. The selected test color image data is converted to color image data of the output unit in operation 850 (hereinafter, referred to as ‘conversion operation’). Then, the test color image data converted to the color image data of the output unit is displayed in operation 860 (hereinafter, referred to as ‘display operation’).

Before the predetermined color image is actually printed, the user determines through the test color image displayed on the display 560 whether or not the output profile created by the gamut mapping algorithms that he/she selected is correct, in operation 870. If the user determines that the output profile created by the selected gamut mapping algorithms is correct, the user inputs a profile selection command through the output profile selection key 516 and selects the output profile created by the selected gamut mapping algorithms as an output profile of the output unit. On the contrary, if the user determines that the output profile created by the selected gamut mapping algorithms is not correct, operations 820 through 870 are repeated so that different gamut mapping algorithms can be selected.

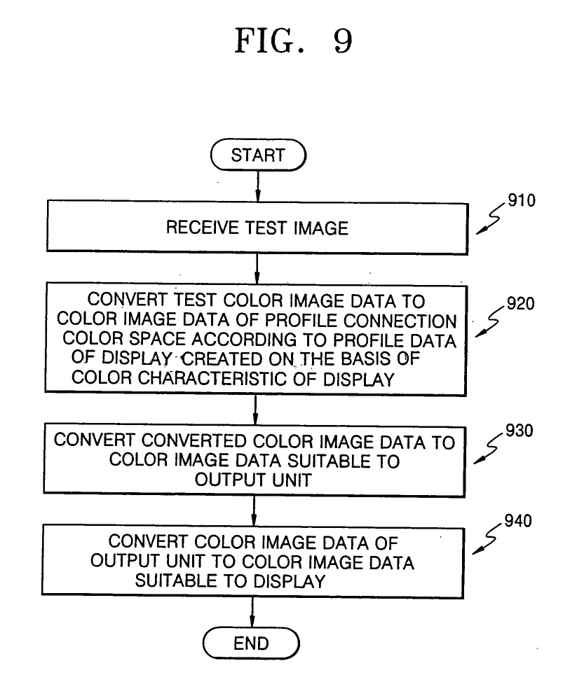

FIG. 9 is a flowchart illustrating a detailed process for implementing operation 850 and operation 860 of FIG. 8, wherein a predetermined test color image is converted so to be displayed on the display 560. If predetermined test color image data is selected by a user's test image selection command input through the test image selection key 560 in operation 910, the test color image data is converted to color image data of a profile connection space according to display profile data created on the basis of a color characteristic of the display 560, in operation 920. Then, the color image data of the profile connection space is converted to color image data of the output unit in operation 930. Successively, the color image data of the output unit is converted to color image data of the display 560, to be displayed on the display 560 in operation 940.

For example, if the output unit is an image printer and the profile connection space is a CIELAB color space, test image data of an RGB color space is converted to image data of the CIELAB color space in operation 920. Then, the image data of the CIELAB color space is converted to image data of the CMYK color space of the image printer on the basis of the created output profile in operation 930. Next, the image data of the CMYK color space is subjected to soft proofing and converted to image data of an RGB color space, so that the image data of the RGB color space is displayed on the display 560 in operation 940.

The present invention may be embodied as a program stored on a computer readable medium that can be run on a general computer. Here, the computer readable medium includes but is not limited to storage media such as magnetic storage media (e.g., ROM's, floppy disks, hard disks, etc.), optically readable media (e.g., CD-ROMs, DVDs, etc.), and carrier waves (e.g., transmission over the Internet). The present invention may also be embodied as a computer readable program code unit stored on a computer readable medium, for causing a number of computer systems connected via a network to affect distributed processing.

As described above, according to the present invention, a user can select a predetermined gamut mapping algorithm according to his/her preference, and create a profile on the basis of the selected gamut mapping algorithm. Also, the user can select a predetermined gamut mapping algorithm according to his/her preference, and test, through a display, a profile created by applying the selected gamut mapping algorithm to a predetermined test image.

Although a few embodiments of the present invention have been shown and described, it would be appreciated by those skilled in the art that changes may be made in these embodiments without departing from the principles and spirit of the invention, the scope of which is defined in the claims and their equivalents.

1. A profile creation apparatus, which creates an output profile of an output unit using profile data of the output unit created on the basis of a color characteristic of the output unit and a gamut mapping algorithm, comprising:
an interface unit through which a selection command is input;
a memory unit storing a plurality of gamut mapping algorithms; and
a profile creator creating the output profile of the output unit, using the profile data of the output unit and a gamut mapping algorithm selected by the selection command from among the plurality of gamut mapping algorithms.

2. The profile creation apparatus of claim 1, wherein the output profile includes different mapping lookup tables corresponding to ‘perceptual’, ‘saturated’, and ‘absolute and relative colorimetric’, which are created by the selected gamut mapping algorithm.

3. The profile creation apparatus of claim 2, wherein one of the plurality of gamut mapping algorithms is selected for each of the gamut mapping lookup tables.

4. The profile creation apparatus of claim 2, wherein the gamut mapping algorithm is selected as a gamut mapping algorithm combination including gamut mapping algorithms corresponding to the respective gamut mapping lookup tables.

5. The profile creation apparatus of claim 1, wherein the gamut mapping algorithm is selected from among a group comprising LCLIP, LLIN, LNLIN, SLIN, LSIN, SLINLAB, and CUSP.

6. A profile creation apparatus, which creates an output profile of an output unit, using profile data of the output unit created on the basis of a color characteristic of the output unit and a gamut mapping algorithm, comprising:
an interface unit through which a selection command is input;
a memory unit storing a plurality of gamut mapping algorithms and a plurality of test color image data;
a profile creator creating the output profile of the output unit, using the profile data of the output unit and a gamut mapping algorithm selected by the selection command among the plurality of gamut mapping algorithms;
a conversion unit converting test color image data selected by the selection command from among the plurality of test color image data to color image data of the output unit, using the created output profile of the output unit; and
a display displaying the converted color image data.

7. The profile creation apparatus of claim 6, wherein the output profile includes different mapping lookup tables corresponding to ‘perceptual’, ‘saturated’, and ‘absolute and relative colorimetric’, which are created by the selected gamut mapping algorithm.

8. The profile creation apparatus of claim 7, wherein one of the plurality of gamut mapping algorithms is selected for each of the gamut mapping lookup tables.

9. The profile creation apparatus of claim 7, wherein the gamut mapping algorithm is selected as a gamut mapping algorithm combination including gamut mapping algorithms corresponding to the respective gamut mapping lookup tables.

10. The profile creation apparatus of claim 6, wherein the conversion unit comprises:
a first converter converting the test color image data to color image data of a profile connection space according to display profile data based on a color characteristic of the display;
a second converter converting the color image data of the profile connection space to color image data of the output unit using the created output profile of the output unit; and
a third converter converting the color image data of the output unit to color image data of the display.

11. The profile creation apparatus of claim 10, wherein the third converter performs soft proofing to convert the color image data of the output unit to the color image data of the display unit.

12. The profile creation apparatus of claim 6, wherein the interface unit comprises:
a first selection key to select the gamut mapping algorithm;
a second selection key to select the test color image data; and
a third selection key to select a profile created by the gamut mapping algorithm as an output profile.

13. The profile creation apparatus of claim 6, wherein the gamut mapping algorithm is selected from among a group comprising LCLIP, LLIN, LNLIN, SLIN, LSIN, SLINLAB, and CUSP.

14. A profile creation method, which creates an output profile of an output unit using profile data of the output unit created on the basis of a color characteristic of the output unit and a gamut mapping algorithm, the method comprising:
(a) receiving the profile data of the output unit;
(b) selecting the gamut mapping algorithm; and
(c) creating the output profile of the output unit using the profile data of the output unit and the selected gamut mapping algorithm.

15. The profile creation method of claim 14, wherein the selecting the gamut mapping algorithm comprises respectively selecting gamut mapping algorithms for different gamut mapping lookup tables corresponding to ‘perceptual’, ‘saturated’, and ‘absolute and relative colorimetric’.

16. The profile creation method of claim 14, wherein the selecting the gamut mapping algorithm comprises selecting a gamut mapping algorithm combination including gamut mapping algorithms corresponding to ‘perceptual’, ‘saturated’, and ‘absolute and relative colorimetric’.

17. The profile creation method of claim 14, wherein the gamut mapping algorithm is selected from among a group comprising LCLIP, LLIN, LNLIN, SLIN, LSIN, SLINLAB, and CUSP.

18. A computer-readable medium having embodied thereon a computer program, which creates an output profile of an output unit using profile data of the output unit created on the basis of a color characteristic of the output unit and a gamut mapping algorithm, the computer program comprising:
a first set of instructions to receive the profile data of the output unit;
a second set of instructions to select the gamut mapping algorithm; and
a third set of instructions to create the output profile of the output unit using the profile data of the output unit and the selected gamut mapping algorithm.

19. A profile creation method, which creates an output profile of an output unit using profile data of the output unit created on the basis of a color characteristic of the output unit and a gamut mapping algorithm, the method comprising:
(a) receiving the profile data of the output unit;
(b) selecting the gamut mapping algorithm;
(c) creating a temporary output profile of the output unit using the profile data of the output unit and the selected gamut mapping algorithm;
(d) selecting test color image data and converting the selected test color image data to color image data of the output unit on the basis of the temporary output profile;
(e) converting the color image data of the output unit to color image data of a display and displaying the color image data of the display on the display;
(f) determining, using the color mage data displayed on the display, whether the temporary output profile is correct; and
(g) if it is determined that the temporary output profile is correct, selecting the temporary output profile as the output profile of the output unit.

20. The profile creation method of claim 19, wherein the selecting the gamut mapping algorithm comprises respectively selecting gamut mapping algorithms for different mapping lookup tables corresponding to ‘perceptual’, ‘saturated’, and ‘absolute and relative colorimetric’.

21. The profile creation method of claim 19, wherein the selecting the gamut mapping algorithm comprises selecting a gamut mapping algorithm combination of gamut mapping algorithms corresponding to ‘perceptual’, ‘saturated’, and ‘absolute and relative colorimetric’.

22. The profile creation method of claim 19, wherein the selecting test color image data and converting the selected test color image data to color image data of the output unit on the basis of the temporary output profile comprises:
converting the selected test color image data to color image data of a profile connection space according to display profile data based on a color characteristic of the display unit; and
converting the converted color image data of the profile connection space to the color image data of the output unit using the temporary output profile.

23. The profile creation method of claim 19, wherein the color image data of the output unit is converted to the color image data of the display unit by soft proofing.

24. The profile creation method of claim 19, wherein the gamut mapping algorithm is selected from among a group comprising LCLIP, LLIN, LNLIN, SLIN, LSIN, SLINLAB, and CUSP.

25. A computer-readable medium having embodied thereon a computer program, which creates an output profile of an output unit using profile data of the output unit created on the basis of a color characteristic of the output unit and a gamut mapping algorithm, the computer program comprising:
a first set of instructions to receive the profile data of the output unit;
a second set of instructions to select the gamut mapping algorithm;
a third set of instructions to create a temporary output profile of the output unit using the profile data of the output unit and the selected gamut mapping algorithm;
a fourth set of instructions to select test color image data and converting the selected test color image data to color image data of the output unit on the basis of the temporary output profile;
a fifth set of instructions to convert the color image data of the output unit to color image data of a display and displaying the color image data of the display on the display;
a sixth set of instructions to determine, using the color mage data displayed on the display, whether the temporary output profile is correct; and
a seventh set of instructions to select the temporary output profile as the output profile of the output unit if it is determined that the temporary output profile is correct.

26. A profile creation method, which creates an output profile of an output unit using profile data of the output unit created on the basis of a color characteristic of the output unit and a predetermined gamut mapping algorithm, the method comprising:
receiving the profile data of the output unit;
selecting the gamut mapping algorithm from among a plurality of gamut mapping algorithms in accordance with a user preference; and
creating the output profile of the output unit using the profile data of the output unit and the selected gamut mapping algorithm.

27. A profile creation method for an output unit, comprising:
receiving profile data of the output unit, including a color characteristic of the output unit;
selecting a gamut mapping algorithm from among a plurality of gamut mapping algorithms in accordance with a user preference; and
creating an output profile of the output unit using the profile data of the output unit and the selected gamut mapping algorithm.
